(19) United States
(12) Patent Application Publication
(10) Pub. No.: US 2026/0015211 A1
(43) Pub. Date: Jan. 15, 2026

(54) LIFTING SYSTEM AND LIFTING METHOD FOR A CRANE

(71) Applicant: Liebherr-Werk Ehingen GmbH, Ehingen/Donau (DE)

(72) Inventor: Ulrich Wiedemann, Ulm (DE)

(21) Appl. No.: 19/333,053

(22) Filed: Sep. 18, 2025

Related U.S. Application Data
(63) Continuation of application No. 17/749,375, filed on May 20, 2022, now abandoned.

(30) Foreign Application Priority Data
May 21, 2021 (DE) 102021113314.9

(51) Int. Cl. B66D 3/06; B66C 1/34; B66D 3/26

(52) U.S. Cl. CPC B66D 3/06; B66C 1/34; B66D 3/26; B66C 2700/0371; B66D 2700/0108

(57) ABSTRACT

A lifting system for a crane for generating a hoist rope pretension during a travel of a suspension element of the crane is provided. The system includes a separable pretension hook block and a connected auxiliary rope that is supported in a windable and unwindable manner on an auxiliary winch on the crane, and that is guided over a deflection apparatus arranged or installable at a boom of the crane. The pretension hook block comprises two lockable hook block parts that are releasably lockable to one another, that are connected to one another via the auxiliary rope, and of which an upper hook block part has a fastening means for fastening to the suspension element of the crane and a lower hook block part has a pick-up means for fastening a weight.

### CROSS-REFERENCE TO RELATED APPLICATIONS

This application is a continuation of U.S. patent application Ser. No. 17/749,375 (filed 20 May 2022), which claims priority to German patent application 10 2021 113 314.9 (filed 21 May 2021), the entire disclosures of which are incorporated herein by reference.

### BACKGROUND

### Technical Field

The present invention relates to a lifting system for a crane, in particular for a mobile crane or crawler crane, for generating a hoist rope pretension during a travel of a suspension element of the crane, to a crane having such a lifting system, to a pretension hook block, and to a method of lifting a suspension element of crane using such a lifting system.

### State of the Art

With most cranes, the taking up and lifting of loads takes place via hoist ropes that carry loads via suspension elements (as a rule hook blocks having a lifting hook), that are guided via deflection means at a crane boom, and that are supported on hoist winches in a windable and unwindable manner. In this respect, the hoist ropes are typically supported on the hoist winches in multiple layers. To avoid “tangles” during the reeling process, the hoist ropes have to be wound as tight as possible in the lower layers on the hoist winches. In the normal lifting process, the larger part of the hoist rope is unreeled during a load pick-up and is reeled up onto the hoist winch during the lifting process. In this respect, the load generates the required pretension on the reeled up hoist rope so that it is reeled onto the hoist winch sufficiently tautly.

If dismantling processes (e.g. chimney dismantling or wind turbine dismantling) are carried out by the crane, loads often have to be picked up at great height and placed down on the ground. The hook block is reeled up as “empty”, i.e. without a load, for this purpose; the load is subsequently picked up at height and then placed on the ground.

This means that the lower layers of the hoist rope are only pretensioned with the aid of the hook block's own weight during the reeling up onto the hoist winch and the load is only picked up at the topmost layer of the winch. The risk of rope tangles and thus of roe damage up to ropes in a replacement state of wear is thereby very high in such dismantling processes.

To circumvent this problem, the hook block weight is currently increased in the simplest case, for example by using a larger lifting hook and/or additional weights. In addition, where possible, the reeving of the hook block can be selected as small as possible and a switch to a parallel operation with two winches can be made. The length of the hoist rope unreeled from a winch drum is reduced by these measures and the pretension on the hoist rope is simultaneously increased by the smaller reeving at the same weight of the hook block. The use of a heavy hook block, however, results in a reduction of the maximum possible working load of the crane.

The possibility is furthermore known from the prior art of pulling up an additional weight together with the otherwise empty lifting hook and to place it on the structure or similar. This has the same effect as an increase of the weight of the hook block, but has the advantage that the additional weight does not remain on the hook block during the actual loading stroke from the height to the ground and the available payload is thus not reduced. The disadvantage here is that there is no possibility in most cases of placing or storing such an additional weight on the structure or similar. at the load pick-up point.

A pretension winch is known as a further solution option from DE 20 2013 006 584 U1 that pulls on the lifting hook weighted by a ballast weight of a crane on the ground and so generates an additional pretension on the hoist rope. However, this requires the provision of a further auxiliary vehicle at the construction site.

### BRIEF DESCRIPTION

It is therefore the underlying object of the present invention to ensure a good winding quality on the winding of the hoist rope onto the hoist winch without further auxiliary vehicles having to be used for this purpose or without there being a need for a placing down of a weight at a great height.

This object is achieved in accordance with the invention by a lifting system having the features of claim 1, by a pretension hook block having the features of claim 11, and by a method in accordance with claim 12. Advantageous embodiments of the invention result from the dependent claims and from the following description.

Accordingly, a lifting system for a crane, in particular for a mobile crane or crawler crane, is proposed for the generation of a hoist rope pretension during a lifting of a suspension element of the crane. The lifting system in accordance with the invention comprises a separable pretension hook block and an auxiliary rope connected thereto that is stored in a windable and unwindable manner on an auxiliary winch arranged or installable at the crane and that is guided via a deflection apparatus arranged or installable at a boom of the crane. The pretension hook block can be raised and lowered relative to the deflection apparatus by winding and unwinding the auxiliary rope. In accordance with the invention, the pretension hook block comprises two hook block parts that are releasably lockable to one another, that are connected to one another via the auxiliary rope and of which an upper hook block part has a fastening means for fastening to the suspension element of the crane and a lower hook block part has a pick-up means for fastening or picking up a weight.

If the upper hook block part is connected to the suspension element, it can be lowered and raised together with it. The lower hook block part is connected to a weight to exert a pretension force on the hoist rope of the crane that carries the suspension element by this additional weight and thereby to ensure a good winding quality at the corresponding hoist winch.

Due to the separability of the pretension hook block, the two hook block parts can in particular be moved independently of one another and the weight connected to the lower hook block part does not have to be raised together with the suspension element on the raising of said suspension element. The position or movement of the weight connected to the lower hook block part can be precisely and safely controlled by a skillful control or regulation of the auxiliary winch, for example via a crane control of the crane.

Since the two hook block parts are connected to one another via the auxiliary rope, they can be moved apart or brought together by a corresponding control of the auxiliary winch. The weight connected to the lower hook block part can, for example, be placed on the ground again and can be released from the lower hook block part after the raising of the suspension element to a desired height by a corresponding control of the auxiliary winch so that subsequently the latter can be raised again and brought together with the upper hook block part or can optionally be locked by reeling up the auxiliary rope. Since the pretension hook block “hangs” at the separate auxiliary rope, the pretension hook block can be released from the suspension element in the elevated position so that the latter is available for picking up a part to be dismantled.

The lifting system in accordance with the invention therefore makes it possible to exert a pretension force on the hoist rope by use of an additional weight on the lifting of the “empty” suspension element and thus to ensure a good winding quality, with no external auxiliary equipment or vehicles having to be used with the exception of the weight. The weight generating the pretension force does not have to be placed down in an elevated position here, but can rather remain in the region of the ground. A flexible system that is easy to operate is thereby provided that can be used in dismantling operations to ensure a good hoist rope winding quality and that comprises few parts that are additionally to be taken along.

In the described solution, the load can be held in the proximity of the ground. This is an improvement of the safety aspects. There are always hazards in the region under a suspended load and the region has to be avoided by persons.

Since with a large number of cranes, for example with lattice mast crane (i.e. cranes with lattice booms), an auxiliary winch having an auxiliary rope and a mast nose that can be installed at the boom tip already belong to the standard equipment, only the pretension hook block in accordance with the invention has to be connected to the auxiliary rope in such a case. This does not take up too much space and can be easily taken along on the crane. No complicated conversion of the crane is thus required on a use of a telescopic crane to use the lifting system in accordance with the invention that would require a separate static observation. The lifting system in accordance with the invention can be retrofitted or installed for individual operations simply with existing cranes and can be subsequently removed again.

If it is stated in the present case that the auxiliary winch or hoist winch is wound up or unwound or reeled up or unreeled, it is thereby meant to be expressed in an abbreviated representation that the corresponding auxiliary rope or hoist rope is wound up on or unwound from or reeled up on or unreeled from the winch.

The feature that the upper and lower hook block parts are connected to one another via the auxiliary rope is to be given a wide interpretation and is to be understood such that the auxiliary rope runs between these two hook block parts. The two hook block parts are in particular movable with respect to one another.

Provision is made in a possible embodiment that at least one first deflection pulley is arranged at the upper hook block part and a second deflection pulley is arranged at the lower hook block part via which hook block parts the auxiliary rope is guided. This means that the pretension hook block has at least two reevings for the auxiliary rope.

The reeving of the auxiliary rope can be designed such that its end is fastened to the lower hook block part. A total of three strands thus result together with a deflection pulley provided at the deflection apparatus for the simplest case that the lower and upper hook block parts each have exactly one deflection pulley, with the first strand of the auxiliary rope running between the deflection pulley and the lower hook block part, the second strand running between the lower hook block part and the upper hook block part, and the third strand running from the hook block part for fastening to the lower hook block part. The mass of the suspended weight is here distributed proportionally over the different strands of the hook block. In the case of three strands, two stands contribute to increasing the pretension so that approximately ⅔ of the weight is suspended at the suspension element and tension the hoist rope that is reeled onto the hoist winch.

Different configurations, for example, more than one deflection pulley per upper and/or lower hook block, are naturally also conceivable here.

Provision is made in a further possible embodiment that the pretension hook block has at least one deflection pulley to lead the auxiliary rope laterally past the suspension element that is preferably arranged at the upper hook block part. This additional deflection pulley therefore in particular does not serve the reeving of the auxiliary rope to distribute the weight force of the additional weight, but rather only the leading past of the auxiliary rope. It is, however, alternatively also conceivable that one of the deflection pulleys is simultaneously used for the leading past.

Provision is made in a further possible embodiment that the pretension hook block comprises a guide mechanism by means of which the lower and upper hook block parts can be brought into a defined locked position when brought together. The guide mechanism can here serve the precise alignment of the upper and lower hook block parts and/or enable a simpler introduction of the two hook block parts into one another.

The guide mechanism preferably comprises one or more guide rails. Alternatively or additionally, the guide mechanism can comprise a tongue-and-groove mechanism, wherein the groove can be applied to the lower hook block and the tongue to the upper hook block. The converse case is also possible. The guide mechanism is preferably designed such that the bringing together of the hook block parts takes place automatically in an elevated position without this having to be manually assisted later.

Provision is made in a further possible embodiment that the lower and upper hook block parts have connection means for a releasable locking to one another. The connection means preferably enable a pinning connection of the lower and upper hook block parts by means of one or more pins.

Provision is made in a further possible embodiment that the lower and upper hook block parts are lockable by means of an actuable locking mechanism, wherein the locking mechanism is preferably actively or passively actuable on or after the bringing together of the upper and lower hook block parts. An active actuation can take place, for example, by means of electrically or hydraulically controlled locking pins. However, a passive actuation of the locking mechanism is preferred, in particular triggered on the bringing together of the upper and lower hook block parts. The pretension hook block can thereby have a simple construction design.

Provision is made in a further possible embodiment that the locking mechanism is adapted to lock automatically on the bringing together of the lower and upper hook block parts and preferably comprises a spring element and/or a snap-in mechanism. The snap-in mechanism can, for example, comprise a pivotable hook element that is arranged at the upper or lower hook block part such that on the bringing together of the respective other hook block part, the hook element pivots and the latter snaps back from the upper and lower hook elements by a spring mechanism in a locked position and a pin engages around the other hook block part such that the two hook block parts are locked to one another. Different elements, for example a displaceable latch, can be used instead of the hook element and the pin.

A manual pinning during the bringing together can be dispensed with due to the automatic locking on the bringing together of the hook block parts, whereby the lifting procedure is substantially simplified. It is likewise conceivable that a manual pinning takes place in addition to the automatically actuable locking mechanism.

In a further possible embodiment, a hoist winch is furthermore provided on which a hoist rope connected to the suspension element is supported in a windable and unwindable manner, with the hoist winch and the auxiliary winch preferably being actuable independently of one another and the suspension element and the pretension hook block thereby being liftable independently of one another. The hoist winch and the auxiliary winch are preferably actuable by a crane control.

In a further possible embodiment, a crane control is furthermore provided that is configured to control the hoist winch and the auxiliary winch synchronized such that a weight fastened to the unlocked pretension hook block is held suspended at a certain height above the ground during a lifting of the suspension element by reeling up the hoist winch and simultaneously unreeling the auxiliary winch. The height and/or alignment of the weight can be detectable by corresponding sensors and the values measured can enter into the regulation.

The total pretension procedure can thus advantageously be carried out and monitored by the crane control. The pretension process can therefore correspond to a regular crane operation, for example a monitored two-hook operation, having a hook at the suspension element as the main lift, actuated by the hoist winch, and a hook at the pretension hook block, actuated by the auxiliary winch, having a common load.

The present invention further relates to a crane, in particular to a mobile crane or crawler crane, that comprises the lifting system in accordance with the invention. Both the hoist winch and the auxiliary winch are preferably fastened toa superstructure of the crane and are independently actuable via a crane control.

The suspension element can be a hook block of the crane. Alternatively or additionally, the deflection apparatus can be a mast nose or a folding tip that can be installed at the boom tip and that preferably has at least one deflection pulley over which the auxiliary rope is guided.

The present invention furthermore relates to a pretension hook block of the lifting system in accordance with the invention. The pretension hook block here comprises an auxiliary rope fastening means for fastening the auxiliary rope of the lifting system that is preferably arranged at the lower hook block part. To fasten the auxiliary rope to the pretension hook block, it is reeved into the two hook block parts and is connected to the auxiliary rope fastening means. The same advantages and properties obviously result here as for the lifting system in accordance with the invention so that a repeat description will be dispensed with at this point. The above statements with respect to the possible embodiments of the pretension hook block therefore apply accordingly.

The present invention further relates to a method of lifting a suspension element of a crane using the lifting system in accordance with the invention, the method comprising the following steps:
fastening the pretension hook block to the suspension element;
unlocking the upper and lower hook block parts, for example by removing one or more pins;
fastening a weight to the lower hook block part;
lifting the suspension element by reeling up a hoist rope connected to the suspension element onto a hoist winch, whereby the lower and upper hook block parts move away from one another (i.e. the upper hook block art is pulled upward together with the suspension element while the lower hook block part remains at the weight); and
placing the weight on the ground after a performed travel of the suspension element by unreeling the auxiliary winch while the suspension element is in its raised position and releasing the lower hook block part from the weight.

The same advantages and properties obviously result here as for the lifting system in accordance with the invention so that a repeat description will be dispensed with at this point.

The first three steps can be carried out in any desired order.

Provision is made in a possible embodiment of the method that the lower hook block part is raised by reeling up the auxiliary winch and is brought together with the upper hook block part after the placing down and releasing of the weight so that the hook block parts can be locked to one another, with the locked pretension hook block subsequently preferably being released from the suspension element and being placed on the ground by unreeling the auxiliary winch. The suspension element can now, for example, be connected to a part to be dismantled at a great height and the part can be lowered to the ground. The method can subsequently be repeated so that sufficient pretension force is available fort the hoist rope on every travel of the “empty” suspension element.

The accessibility for unhooking the pretension hook block from the suspension element can be assumed as given since the load to be dismantled has to be lashed to the suspension element in the subsequent state.

Provision is made in a further possible embodiment of the method that the hoist winch and the auxiliary winch are controlled synchronously or synchronized for the lift of the suspension element, in particular via a crane control of the crane, such that the weight is held at a certain height above the ground, in particular suspended, by reeling up the hoist winch and simultaneously unreeling the auxiliary winch.

Provision is made in a further possible embodiment of the method that the travel of the suspension element takes place in a two-hook operation monitored by the crane control, with an automatic regulation of the hoist and auxiliary winches preferably taking place by the crane control such that the weight is held at a defined height above the ground and/or in a specific location.

A use of the system in accordance with the invention such as has been previously presented results from claim 16.

### BRIEF DESCRIPTION OF THE DRAWINGS

Further features, details, and advantages of the invention result from the embodiments explained in the following with reference to the Figures. There are shown:

FIG. 1: a schematic side view of the pretension hook block in accordance with the invention in a locked state suspended at a lifting hook of a crane in accordance with an embodiment;

FIG. 2: the pretension hook block in accordance with FIG. 1 in the unlocked state and having a weight taken up;

FIG. 3: a longitudinal section through the pretension hook block in accordance with the invention;

FIG. 4: a schematic side view of the boom tip of a crane with a suspension element, a mast nose, and a pretension hook block;

FIG. 5: a side view and a front view of the pretension hook block in accordance with the invention;

FIG. 6: a schematic representation of the connection regions of the upper and lower hook block parts of the pretension hook block in accordance with the invention in accordance with an embodiment;

FIG. 7: a side view of the superstructure of the crane in accordance with an embodiment with an indicated location of the hoist winch; and

FIGS. 8 to 11: different positions of the suspension element and the pretension hook block during the carrying out of the lifting method in accordance with the invention in accordance with an embodiment, in a side total view of the crane in each case.

### DETAILED DESCRIPTION

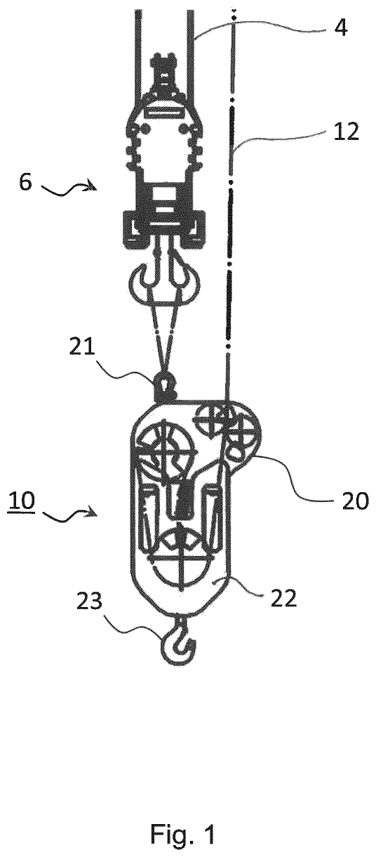

FIG. 1 shows a schematic side view of the pretension hook block 10 of the lifting system in accordance with the invention in accordance with a preferred embodiment. The pretension hook block 10 is suspended at a suspension element 6 of a crane 1, with it here being a crawler crane 1 in the embodiments shown here.

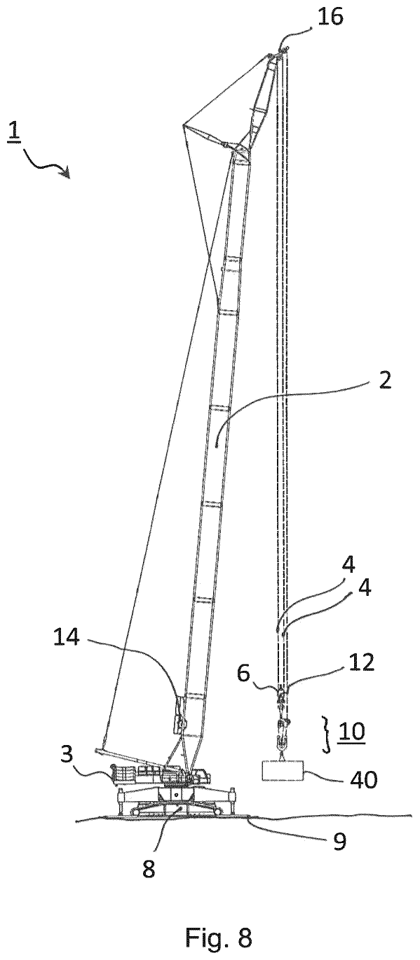

The crane 1, that is shown in a total side view in FIGS. 8 to 11, comprises an undercarriage 8 having a crawler unit, a superstructure 3 supported on the undercarriage 8 rotatably about a vertical axis, a boom 2 connected in an articulated manner to the superstructure 3 pivotably about a horizontal axis, and a suspension element 6 for lifting loads that is designed as a roller frame 6a having a lifting hook 6b in the embodiments shown here.

The superstructure 3 of the crane 1 is shown isolated in a side view in FIG. 7. A hoist winch 5 on which a hoist rope 4 is windably and unwindably supported is located on the superstructure 3. The hoist rope 4 is connected to the suspension element 6 so that the suspension element 6 can be raised and lowered by actuating the hoist winch 5 or by reeling and unreeling the hoist rope 4.

The crane 1 furthermore has an auxiliary winch 14 on which an auxiliary rope 12 is windably and unwindably supported. As can be seen in FIG. 8, the auxiliary winch 14 is located in the lower region of the boom 2.

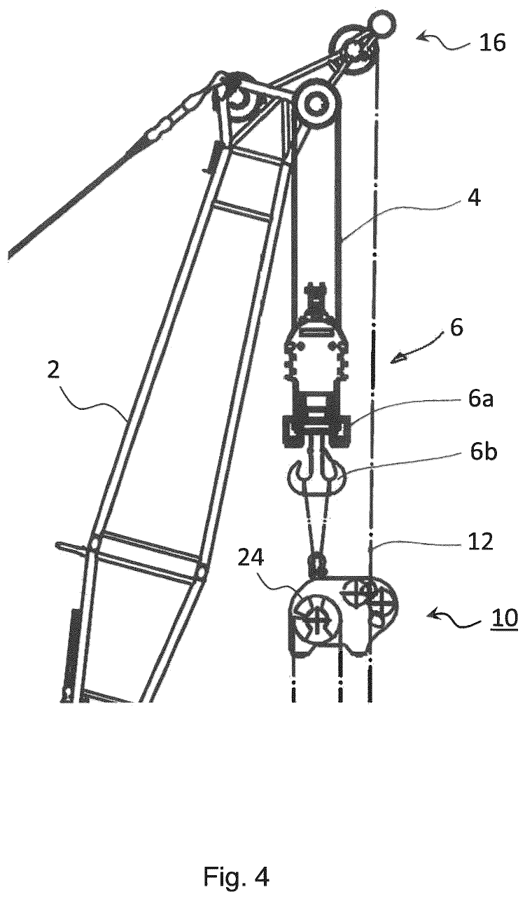

As is indicated in FIG. 4, the hoist rope 4 is guided at the boom tip to the hoist winch 5 over a deflection pulley of a roller head. A deflection apparatus 16 that is configured as a mast nose and has a deflection pulley over which the auxiliary rope 12 is guided is installed at the boom tip.

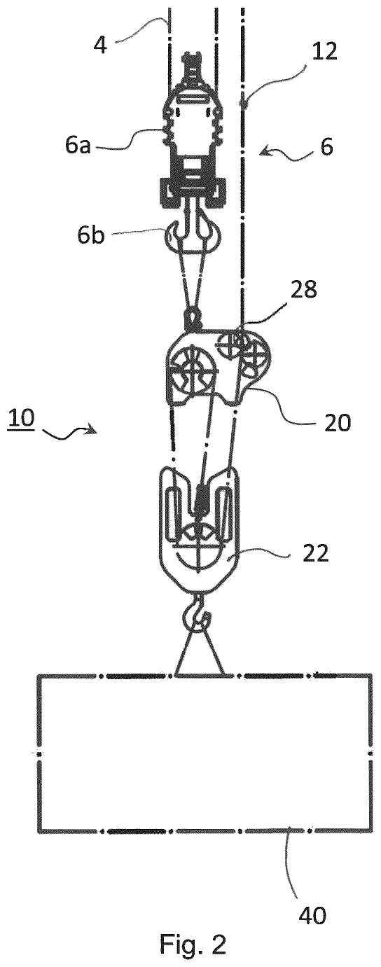

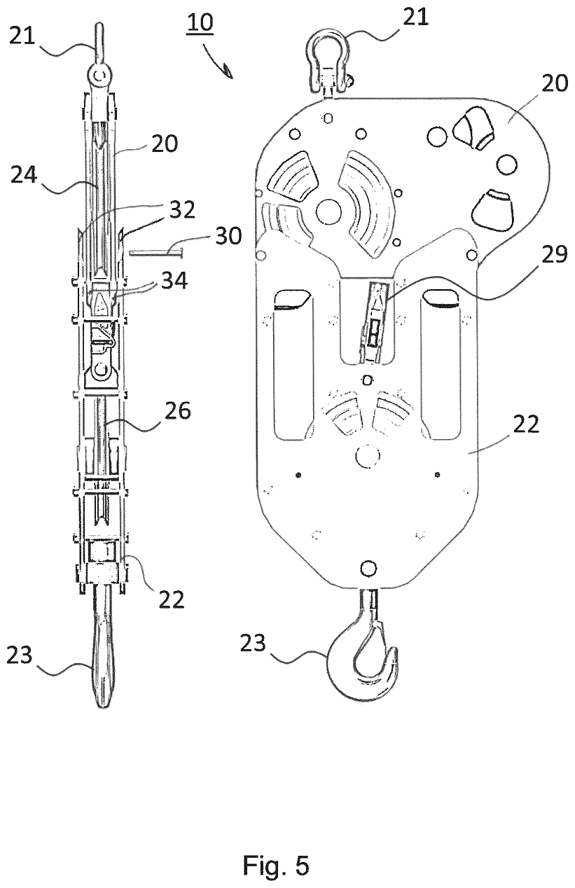

Reference is made in the following to FIGS. 1 to 3 that show the pretension hook block 10 in accordance with the invention in a locked state (FIG. 1) and in an unlocked state (FIGS. 1 to 2). FIG. 5 additionally shows side and front views of the pretension hook block.

The pretension hook block 10 in accordance with the invention is designed in two parts and comprises an upper hook block part 20 (upper block) and a lower hook block part 22 (lower block). A fastening means 21 via which the pretension hook block 10 can be lashed or fastened to the lifting hook 6b of the crane 1 is located at the upper side of the upper hook block part 20. A pick-up means 23 in the form of a further lifting hook to which a load or a weight 40 can be fastened is located at the lower side of the hook block part 22.

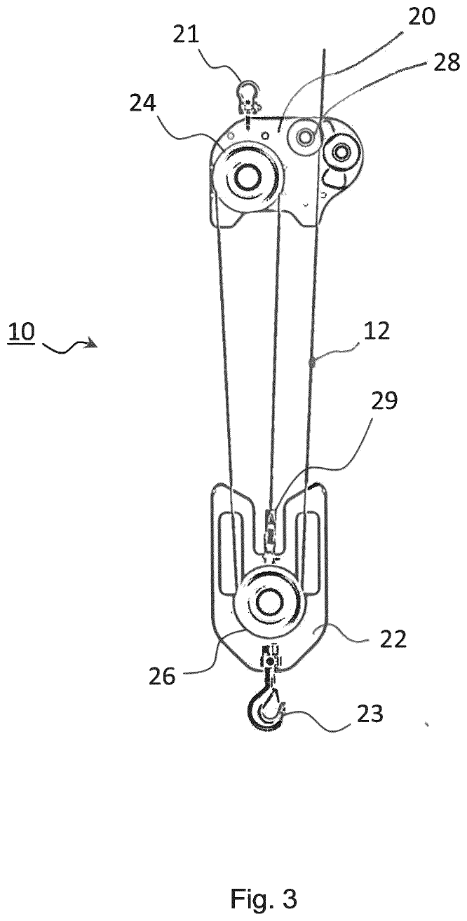

The two hook block parts 20, 22 can be locked to one another so that the pretension hook block 10 can be moved or raised as a whole (see FIG. 1). The locking can take place by means of one or more pins 30. As can in particular be recognized in FIG. 3, the upper hook block part 20 has a first deflection pulley 24 while the lower hook block part 22 comprises a second deflection pulley 26. The auxiliary rope 12 guided over the mast nose 16 is guided or reeved, starting from the mast nose 16, over the second deflection pulley 26 of the lower hook block part 22 and subsequently over the first deflection pulley 24 of the upper hook block part 20 and is connected to the lower hook block part 22 via a fastening means 29. The upper hook block part 20 furthermore has a further deflection pulley 28 to lead the auxiliary rope 12 laterally past the suspension element 6. The two hook block parts 20, 22 are connected to one another via the auxiliary rope 12 such that the spacing of the two hook block parts 20, 22 from one another is variable by a suitable control of the auxiliary winch 14.

A sufficiently great pretension on the lifting of the suspension element can be generated on the hoist rope 4 by means of the pretension hook block 10 in accordance with the invention in combination with the auxiliary winch 14, the auxiliary rope 12, and the mast nose 16 so that said hoist rope 4 is tautly wound onto the hoist winch 5. The occurrence of tangles is thereby prevented and a good winding quality is ensured.

If the suspension element 6 is to be raised by the crane 1 without an attached load for the purpose of a dismantling of a higher component, a weight 40 is fastened to the pick-up means 23 of the lower hook block part 22 of the pretension hook block 10 fastened to the suspension element 6, as is shown in FIG. 2. The weight 40 is connected via the pretension hook block 10 to the suspension element 6 and thus to the hoist rope 4 and generates a suitable pretension force.

The pulley block of the pretension hook block 10 implemented via the deflection pulleys 24, 26 and the fastening means 29 has the effect that the weight force of the weight 40 fastened to the pick-up means 23 is spread over the different strands of the auxiliary rope 12. Since the reeving of the auxiliary rope 12 of the pretension hook block 10 is selected with three reevings, with the first strand leading to the mast nose 16, two strands contribute to the increase of the pretension, i.e. approximately ⅔ of the ballast weight is suspended at the suspension element 6 and tension the hoist rope 4 that is reeled onto the hoist winch 5. More than three reevings of the auxiliary rope 12 or more than one respective deflection pulley 24, 26 can naturally be provided at the hook block parts 20, 22 here.

The two deflection pulleys 24, 26 have parallel axes of rotation. The fastening means 29 is located above the second deflection pulley 26 at the lower hook block part 22 while the pick-up means 23 is arranged beneath the second deflection pulley 26. The further deflection pulley 28 is located obliquely above the first deflection pulley 24 at the upper hook block part 20 while the fastening means 21 is arranged above the first deflection pulley 24.

As can be seen in FIG. 4, the spacing between the first deflection pulley 24 and the further deflection pulley 28 can substantially correspond to the spacing between the corresponding deflection pulleys for the hoist rope 4 and the auxiliary rope 12 at the boom head or at the mast nose 16.

As can be seen in FIG. 5, the two hook block parts 20, 22 can be pushed into one another, with the upper hook block part 20 having a pick-up region 34 configured as a tongue into a pick-up region of the lower hook block part 22 configured as a groove 32. The pick-up regions 32, 34 can be chamfered, whereby the threading or pushing in is facilitated.

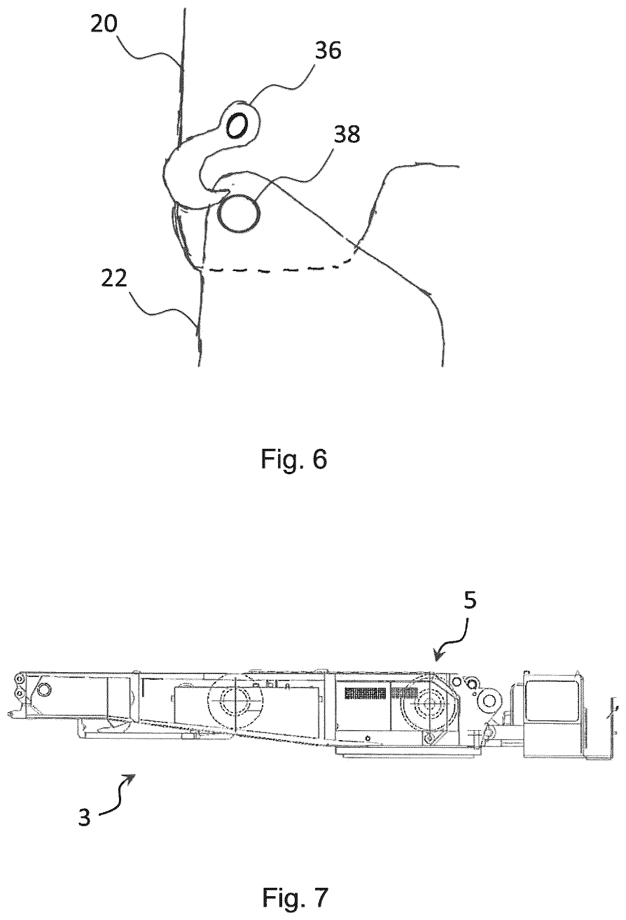

As described above, the two hook block parts 20, 22 can be manually lockable via pins 30 (see also FIG. 5). An alternative embodiment is shown in sketched form in FIG. 6 in which the pretension hook block 10 has a locking mechanism. A retaining pin 38 is accordingly arranged in the upper region of the lower hook block part 22 while a pivotable hook element 36 is located at the lower region of the upper hook block part 20. On the brining together of the two hook block parts 20, 22, the pin 38 automatically pushes the hook 36 to the side and pivots it about its pivot axis, as shown. Once the hook block parts 20, 22 have reached their completely retracted licking position, the hook 36 snaps in and automatically locks the two hook block parts 20, 22. A spring element, not shown in any more detail, can be provided for this purpose that forces the hook 36 into its locked position. The hook block parts 20, 22 thereby do not have to be manually locked, which in particular facilitates the bringing together at great heights.

FIGS. 8 to 11 show an overall side view of the crane 1 during a travel of the suspension element 6 in accordance with an embodiment of the method in accordance with the invention. A start is made in this respect from the situation that a load is to be taken up from an elevated position and is to be placed on the ground 9 for dismantling. To be able to lift the suspension element 6 to the height of the load to be taken up with sufficient pretension, the previously lowered suspension element 6 is connected in a first step via the pretension hook block 10 to a weight 40. The pretension hook block 10 is suspended at the lifting hook 6b in the locked state. The weight 40 is fastened to the pick-up means 23 of the pretension hook block 10. During the suspending at the lifting hook 6b, the pretension hook block 10 can either already be connected to the auxiliary rope 12 or, for example during the first travel, the auxiliary rope 12 Is reeved into the pretension hook block 10 after the suspension thereof.

The pretension hook block 10 is now unlocked or unpinned and the weight 40 is raised slightly by actuation of the hoist winch 5 and the auxiliary winch 14 (see FIG. 8). The weight 40 can be raised from the ground here. The weight 40 can be held closely above the ground 9, in particular suspended, during the raising of the suspension element 6 by reelin gup the hoist winch 6 and simultaneously unreeling the auxiliary winch 14, preferably by a corresponding control and monitoring of the crane control. As long as the weight 40 is in the suspended state, a high pretension is applied to the hoist rope 4 or to the hoist winch 5 due to its weight.

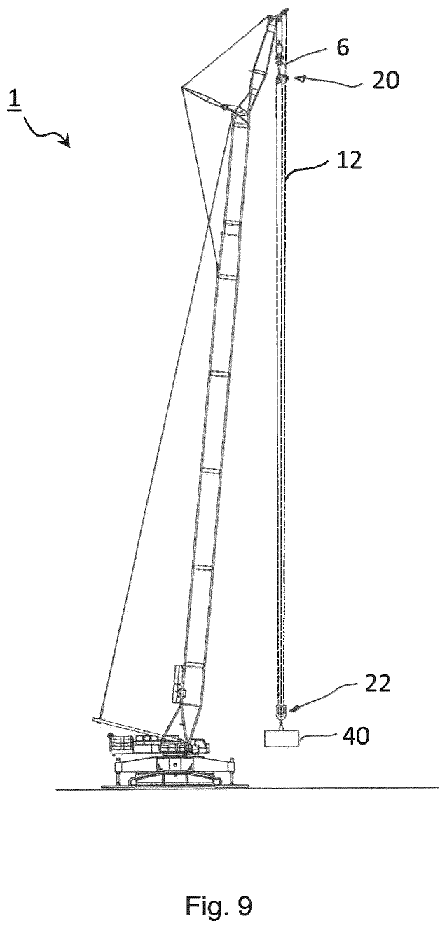

Once the suspension element 6 has been pulled up completely, i.e. up to the desired height, via the hoist rope 4 by means of the hoist winch 5 (see FIG. 9). the auxiliary winch 14 is unreeled, the lower hook block part 10 is let down, and the weight 40 is placed on the ground 9 and unhooked.

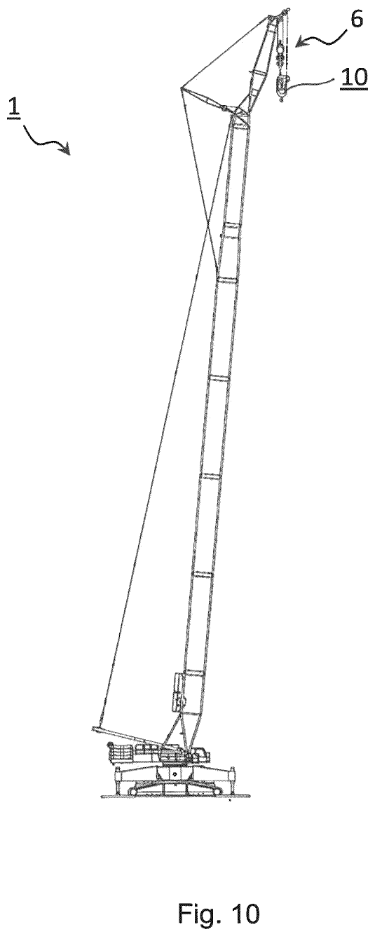

The lower hook part 22 is subsequently pulled up by reeling up the auxiliary winch 14 and is guided to the upper hook block part 20. Once the hook block parts 20, 22 are in their locked position, they can be pinned together (or an automatic locking takes place as explained above). This can take place from the elevated position where the load to be conveyed or to be placed down also has to be taken up. FIG. 10 shows the situation after the bringing together and locking of the hook block parts 20, 22 while the pretension hook block 22 of the pretension hook block 10 is still suspended at the suspension element 6.

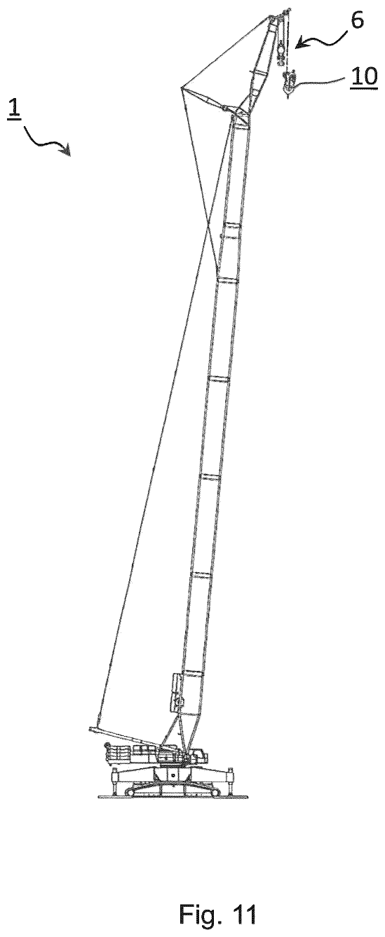

The pretension hook block 10 can now be unhooked from the suspension element 6 of the crane 1 (see FIG. 11) and can subsequently be lowered to the ground 9 by means of the auxiliary winch 14. The suspension element 6 is still in the elevated position and can now be connected to the load to be conveyed. The load can be placed on the ground 9 by actuating the hoist winch 5. The above-explained steps can be carried out again for the next travel of the suspension element 6.

The weight 40 that is raised from the ground 9 and that has the result that the total pretensioning process can be monitored by the control of the crane 1 is advantageous in this method. The pretensioning process corresponds to regular crane operation. It is in this case a monitored two-hook operation having a hook 6b as the main travel at the main or hoist winch 5 and having a hook 23 at the auxiliary winch 14 via the mast nose 16 having a common load.

In this solution, no conversion work is necessary at the crane 1 that would require a separate static observation. Furthermore, no auxiliary vehicle has to be used for the application of the pretension. The auxiliary winch 14 for the auxiliary travel and the short mast nose 16 form part of the standard equipment with many lattice mast cranes and also with large telescopic cranes. The crane 1 can additionally be rotated and/or traveled during the pretensioning process, which is not possible with a solution having an auxiliary vehicle and/or an auxiliary winch placed on the ground.

### REFERENCE NUMERAL LIST

1 crane
2 boom
3 superstructure
4 hoist rope
hoist winch
6 suspension element
6a pulley block
6b lifting hook
8 undercarriage
9 ground
10 pretension hook block
12 auxiliary rope
14 auxiliary winch
16 deflection apparatus (mast nose)
20 upper hook block part
21 fastening means
22 lower hook block part
23 pick-up means (lifting hook)
24 first deflection pulley
26 second deflection pulley
28 deflection pulley
29 auxiliary fastening means
30 pin
32 groove
34 tongue
36 hook
38 pin
40 weight

What is claimed is:

1. A lifting system for a crane for generating a hoist rope pretension during a travel of a suspension element of the crane, the lifting system comprising:
a separable pretension hook block; and
an auxiliary rope that is connected to the pretension hook block, the auxiliary rope is supported in a windable and unwindable manner on an auxiliary winch arranged or installable on the crane, and that is guided via a deflection apparatus that is arranged or installable at a boom of the crane, wherein the pretension hook block comprises two hook block parts that are releasably lockable to one another, that are connected to one another via the auxiliary rope, and of which an upper hook block part has a fastening means located at an upper side of the upper hook block for lashing or fastening the pretension hook block to the suspension element and a lower hook block part has a pick-up means for fastening a weight, wherein the pretension hook block comprises a guide mechanism by which the lower and upper hook block parts are configured to be brought into a defined locked position on bringing together.

2. The lifting system in accordance with claim 1, wherein the upper hook block part comprises at least one first deflection pulley and the lower hook block part comprises at least one second deflection pulley via which the auxiliary rope is guided.

3. The lifting system in accordance with claim 1, wherein the pretension hook block has at least one deflection pulley to lead the auxiliary rope laterally past the suspension element.

4. The lifting system in accordance with claim 1, wherein the lower and upper hook block parts have connections means for the releasable locking to one another.

5. The lifting system in accordance with claim 4, wherein the lower and upper hook block parts are configured to be pinned by one or more pins.

6. The lifting system in accordance with claim 1, wherein the lower and upper hook block parts are lockable by an actuable locking mechanism.

7. The lifting system in accordance with claim 6, wherein the locking mechanism is actively or passively actuable on or after bringing together of the hook block parts.

8. The lifting system in accordance with claim 7, wherein the locking mechanism is adapted to lock automatically on bringing together of the lower and upper hook block parts.

9. The lifting system in accordance with claim 7, wherein the locking mechanism includes one or more of a spring element or a snap-in-mechanism.

10. The lifting system of claim 1, further comprising:
a hoist winch on which a hoist rope connected to the suspension element is supported in a windable and unwindable manner.

11. The lifting system in accordance with claim 10, further comprising:
a crane control that is configured to control the hoist winch and the auxiliary winch synchronized such that a weight fastened to the pretension hook block that is unlocked is held suspended at a certain height or in a certain region above ground during a travel of the suspension element by reeling up the hoist winch and simultaneously unreeling the auxiliary winch.

12. The crane having the lifting system in accordance with claim 1.

13. The pretension hook block of the lifting system in accordance with claim 1 and having an auxiliary rope fastening means for fastening the auxiliary rope.

14. A method of lifting the suspension element of the crane using the lifting system in accordance with claim 1, the method comprising:
fastening the pretension hook block to the suspension element that is lowered;
unlocking the upper and lower hook block parts;
fastening the weight to the lower hook block part;
lifting the suspension element, whereby the lower and upper hook block parts move away from one another; and
placing the weight down by unreeling the auxiliary winch while the suspension element is in its raised position and releasing the lower hook block part from the weight.

15. The method in accordance with claim 14, wherein the lower hook block part is raised by reeling up the auxiliary winch and is brought together with the upper hook block part after placing down and releasing of the weight so that the hook block parts can be locked to one another.

16. The method in accordance with claim 14, wherein the hoist winch and the auxiliary winch are controlled synchronously or synchronized for the travel of the suspension element.

17. The method in accordance with claim 16, wherein travel of the suspension element takes place in a two-hook operation monitored by the crane control.

18. A method for use of the lifting system in accordance with claim 1, comprising:
fastening the pretension hook block to the suspension element that is lowered;
unlocking the upper and lower hook block parts;
fastening the weight to the lower hook block part;
lifting the suspension element, whereby the lower and upper hook block parts move away from one another; and
simultaneous unreeling the auxiliary winch such that the weight remains on ground and a constant strand tension is present in the auxiliary rope.

19. The lifting system in accordance with claim 1, wherein the guide mechanism includes one or more of (a) at least one guide rail or (b) a tongue-in-groove mechanism.

20. A lifting system for a crane for generating a hoist rope pretension during a travel of a suspension element of the crane, the lifting system comprising:
a separable pretension hook block;
an auxiliary rope that is connected to the pretension hook block, the auxiliary rope is supported in a windable and unwindable manner on an auxiliary winch arranged or installable on the crane, and that is guided via a deflection apparatus that is arranged or installable at a boom of the crane, wherein the pretension hook block comprises two hook block parts that are releasably lockable to one another, that are connected to one another via the auxiliary rope, and of which an upper hook block part has a fastening means located at an upper side of the upper hook block for lashing or fastening the pretension hook block to the suspension element and a lower hook block part has a pick-up means for fastening a weight;
a hoist winch on which a hoist rope connected to the suspension element is supported in a windable and unwindable manner; and
a crane control that is configured to control the hoist winch and the auxiliary winch synchronized such that a weight fastened to the pretension hook block that is unlocked is held suspended at a certain height or in a certain region above ground during a travel of the suspension element by reeling up the hoist winch and simultaneously unreeling the auxiliary winch.
